(19) United States
(12) Patent Application Publication
(10) Pub. No.: US 2003/0144769 A1
(43) Pub. Date: Jul. 31, 2003

(54) Security system for preventing aircraft hijacking

(76) Inventor: Dieter Meier, Fuerth (DE)

Correspondence Address: JORDAN AND HAMBURG LLP, 122 EAST 42ND STREET, SUITE 4000, NEW YORK, NY, 10168, US

(21) Appl. No.: 10/298,477

(22) Filed: Nov. 14, 2002

(30) Foreign Application Priority Data
Nov. 22, 2001 (DE) 101 57 383.9-22

(51) Int. Cl. B64D 45/00

(52) U.S. Cl. 701/3; 340/945

(57) ABSTRACT

A security system for preventing the hijacking of aircraft, which are provided with an autopilot with stored flight routes, wherein an emergency switch-over device for actuating the autopilot, when actuated, prevents the autopilot being switched off again in the cockpit.

The invention relates to a security system to prevent the hijacking of aircraft, which are provided with an autopilot with a stored flight route.

Since the most recent dramatic cases, the prevention of aircraft hijacking, in which aircraft are not hijacked simply to an airport, other than the one, which was originally intended and, instead are used by suicide assassins as bombs to destroy high-rise buildings or other important industrial objects, has reached a completely new importance. Attention now no longer is focused on protecting the passengers of an aircraft, so that they are no longer taken hostage for ransom; in many such cases of hijacking, an attack on the lives of the passengers of the aircraft is not intended and also does not take place. Instead, it has become necessary to prevent the possibility that thousands or tens of thousands of people can be killed by such a hijacking.

It is therefore an object of the invention to provide a security system, which can prevent hijacking of aircraft and cannot be overcome my any form of threats and blackmail.

Pursuant to the invention, this objective is accomplished by a security system, wherein an emergency switch-over device for actuating the autopilot, when actuated in the cockpit, prevents any switching off of the autopilot.

The emergency switch-over device, which preferably blocks the normal on-off switch of the autopilot, can be actuated, in a development of the invention by a separate emergency switch in the cockpit, which cannot be reset. Once the emergency switch-ever device has been actuated, there is no possibility within the cockpit of countermanding this actuation. The aircraft then is controlled by the autopilot and flies its programmed flight route to the destination airport, where it can also be landed without intervention by the pilot. In those cases, in which the destination airport does not have automatic landing facilities for taking over the aircraft coming in on autopilot, it is possible, in a further development of the invention, when programming the autopilot flight route, to program an alternative route from the very start to a different airport, which is selected automatically when the autopilot is actuated over the emergency switch-over device and is accorded priority over the actual “normal” flight route.

In cases where it can be demonstrated clearly that the emergency switch-over device has been actuated falsely and that such false actuation is not just illusionary due to force exerted on the personnel of the aircraft, the device can be acted upon and the autopilot switched off again over a radio connection, which is not accessible from the cockpit, by means of a special code key from outside of the cockpit, especially from the destination airport.

This radio connection to the switch-over device, using a complicated code key also opens up a further advantageous development of the inventive security system. This is characterized by a radio-triggering device for the switch-over device, which can be actuated from outside of the cockpit by an undercover security agent or even better yet by a fighter interceptor plane, which has received the necessary code information from the destination airport. This actuation from an accompanying aircraft has the advantage that the risk, which, in the final analysis is not too great, that an undercover security officer is disarmed and the switch-over device taken away from him, is avoided.

This device not only makes it possible to switch the autopilot off again when such an emergency switching device has been actuated accidentally, since such an undercover security officer can recognize very accurately whether a hijacking is actually taking place, but also enables the device, for switching over to autopilot, to be switched over from the accompanying plane in the event that the hijackers of the aircraft have succeeded in eliminating the personnel of the cockpit so quickly that the latter were unable to actuate the switch-on knob for the emergency switch-over device. Simultaneously with the activation of the emergency switch, the contact station on the ground is informed by radio of the attempted hijacking.

Finally, such a security system also has the advantage that, when it is introduced, a large number of aircraft hijackings surely will no longer be planned and carried out, since they are bound to fail from the very start, because the aircraft hijackers have no possibility of forcing those on board to switch off the autopilot once again after it has been switched on.

Further advantages, distinguishing features and details of the invention arise out the following description of an example and from the drawing, which diagrammatically shows a block diagram of the inventive security system.

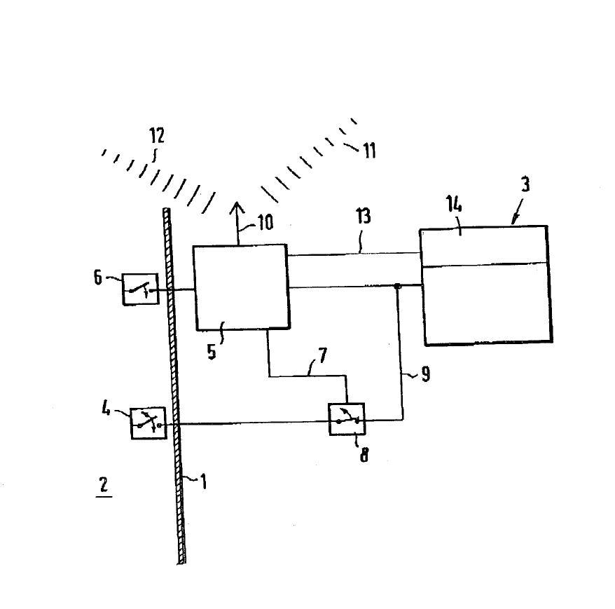

In the FIG. 1, is a partition, which separates the parts of the security system on the right of the partition from the cockpit 2 on the left. The space on the right of the partition 1 is therefore not accessible from the cockpit. Even if the instrument wall were to be destroyed, this would not help, since the devices to the right of the partition are hidden, cannot be recognized readily and may be disposed anywhere within the interior of the aircraft controls.

The autopilot 3 of the aircraft normally is actuated over an on-off switch 4 by the pilot in the cockpit, it being possible to switch the autopilot on and off at will by the on-off switch 4. Pursuant to the invention, an emergency switching device 5 is provided, which can, however, only switched on over the emergency switch 6 but no longer be switched off. This emergency switch-over device does not only switch the auto pilot 3 on but also, at the same time, over a control lead 7, opens an interrupt initiation switch 8 in the triggering circuit 9 of the on-off switch 4 to the autopilot 3. When the emergency switchover device 5 has been actuated and, in addition, the interrupt initiation switch 8 has been also actuated in order to switch on the autopilot 3, the on-off switch 4 for the autopilot becomes completely ineffective. In order to switch off the autopilot once again, the emergency switch-over device can be actuated only by a radio connection, indicated by the antenna 10, either by means of a radial signal 11 from a destination airport or by means of a radio signal 12 from the radio-control device of an undercover security officer in the passenger compartment of the aircraft or by the radio-control device from an accompanying aircraft, which has received the code information from the destination airport.

At 13, a control lead can be seen, which extends from the emergency switch-over device to the air route memory 14 of the autopilot. Aside from the “normal” flight route, one or more alternative routes for the respective flights are contained in this flight route memory, especially so that, in the event of a flight that leads to an airport, which does not have an automatic landing system, the actuation of the emergency switch-over device 5 automatically switches over to a different flight route, so that, with the help of the autopilot, which can no longer be switched off, the aircraft heads for an airport, on which the aircraft can be landed automatically even without the intervention of the pilot. In this connection, the embodiment can, of course, be such that different alternative routes can be selected depending on how far the flight has already progressed, a route preferably being selected, which rapidly leads to the landing of the aircraft.

1. A security system for preventing the hijacking of aircraft, which are provided with an autopilot with stored flight routes, wherein an emergency switch-over device (5) for actuating the autopilot (3), when actuated, prevents the autopilot (3) being switched off again in the cockpit (2).

2. The security system of claim 1, wherein a separate emergency switch (6) in the cockpit (2) which cannot be switched off, is assigned to the emergency switch-over device (5).

3. The security system of claims 1 or 2, wherein the emergency switch-over device (5) blocks the normal on-off switch for the autopilot.

4. The security system of one of the claims 1 to 3, wherein the emergency switch-over device (5) can be actuated to switch off the autopilot (3) once again by way of a radio connection (10), which is not accessible from the cockpit (2), by means of a special code key from outside of the cockpit, especially from the destination airport.

5. The security system of claim 4, wherein the radio triggering device for the emergency switch-over device (5) can be actuated from outside the cockpit by an undercover security officer in the aircraft or by an accompanying aircraft (interceptor fighter).

6. The security system of one of the claims 1 to 5, wherein at least one flight route to an alternate airport, which is provided with an automatic landing system, is programmed in the autopilot (3) and is accessed automatically when the emergency switch-over device (5) is actuated.

7. The security system of one of the claims 1 to 6, wherein the destination airport and/or the next ground station is/are informed automatically when the emergency switch-over device is activated.
